(19) United States
(12) Patent Application Publication
(10) Pub. No.: US 2006/0224581 A1
(43) Pub. Date: Oct. 5, 2006

(54) Information retrieval system

(75) Inventor: Kosuke Sasai, Kobe-shi (JP)

Correspondence Address: BRINKS HOFER GILSON & LIONE, P.O. BOX 10395, CHICAGO, IL, 60610, US

(73) Assignee: KONICA MINOLTA HOLDINGS, INC.

(21) Appl. No.: 11/393,085

(22) Filed: Mar. 30, 2006

(30) Foreign Application Priority Data
Mar. 31, 2005 (JP) JP2005-102476

(51) Int. Cl. G06F 17/30

(52) U.S. Cl. 707/5

(57) ABSTRACT

In an information retrieval system for retrieving in a data group to be searched, which is stored in a database, a logic model expressing a logic guide in a searching process is developed by additionally registering synonyms and the like to a search keyword by a number of users. By temporarily registering a new data group to be edited into the database, a searching function obtained by developing the logic model can be used also for a searching process on the new data group.

This application is based on application No. 2005-102476 filed in Japan, the contents of which are hereby incorporated by reference.

### BACKGROUND OF THE INVENTION

1. Field of the Invention

The present invention relates to an information retrieval system.

2. Description of the Background Art

A technique is provided that can address to a dynamic event change which is continuous with time by making the intention (knowledge and experience) of the user always reflected in a data structure and a search logic in an information retrieval system which is accessed by many people (for example, Japanese Patent Application Laid-Open No. 2004-234404).

In the technique, a logical model expressing a logical guideline in a retrieving process without depending on concrete data of a data group is configured. On the other hand, by reflecting a result of analysis of a logical path connecting a known condition in an event group as an object of information of the data group and a known result corresponding to the condition into the logical model, the logical model is developed whenever necessary. By changing a data structure and a search logic in accordance with development of the logical model, the intention (knowledge and experience) of the user can be reflected in the data structure and the search logic whenever necessary.

In such an information retrieval system, an editing work of adding new contents to a database to be searched is performed whenever necessary. However, various works such as clustering included in the editing work are very difficult.

As a technique for supporting the data editing work, a technique of storing edition information including an editing operation procedure and re-using the stored edition information has been proposed (for example, Japanese Patent Application Laid-Open No. 07-57115 (1995)).

The technique disclosed in Japanese Patent Application Laid-Open No. 07-57115 (1995) reuses the edition procedure itself but does not provide information used as an indicator at the time of clustering contents, so that it cannot solve the problem of the difficulty of the editing work of adding contents to a database to be searched.

### SUMMARY OF THE INVENTION

The present invention is directed to an information retrieval system in which a logic model expressing a logic guide in a searching process is developed in response to a request for a searching process from a user.

According to the present invention, the information retrieval system includes: a storage that stores a first data group; a first searching unit for searching in the first data group in response to a first search condition entered by an operation of the user and obtaining a first search result on the basis of the logic model; a registering unit for registering a second data group into the storage so as to be distinguished from the first data group; and a second searching unit for searching in the second data group in response to a second search condition entered by an operation of the user on the basis of the logic model in an editing work state in which the second data group is registered in the storage, and obtaining a second search result.

By enabling a searching function of the information retrieval system in which the logic model expressing the logic guide in the searching process is developed in response to a request for a searching process from a user to be used also for the second data group which is registered so as to be distinguished from the first data group, the searching function developed on the basis of the intention of the user can be used also for the second data group to be edited. Thus, the editing work of adding new contents to the database to be searched can be facilitated.

Therefore, an object of the present invention is to provide a technique of facilitating the editing work of adding new contents to a database to be searched.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram schematically showing improvement in satisfaction level by a search support function;

FIG. 2 is a diagram showing main components of an information retrieval system having a compilation support function;

FIG. 3 is a diagram showing the structure of a paper;

FIG. 4 is a block diagram showing the configuration of a search function and a search support function of an information retrieval system;

FIG. 5 is a block diagram showing a detailed function configuration of a keyword determining unit 11;

FIG. 6 is a diagram showing an example of an XML document describing a decomposition result;

FIG. 7 is a diagram showing a graph used for expressing dependency between clauses;

FIG. 8 is a block diagram showing a detailed functional configuration of a keyword candidate determining unit 13;

FIG. 9 is a diagram illustrating a mode selection screen;

FIG. 10 is a diagram illustrating an authentication screen;

FIG. 11 is a diagram illustrating a search target designation screen;

FIG. 12 is a diagram illustrating a first search screen;

FIG. 13 is a diagram illustrating a re-search screen;

FIG. 14 is a diagram showing a new re-search screen after the re-search;

FIG. 15 is a diagram showing a state where paper data is extracted from a search result;

FIGS. 16 to FIGS. 18 are diagrams showing a co-author relation screen;

FIGS. 19 and 20 are both flowcharts showing schematic operation of an information retrieval system;

FIG. 21 is a diagram illustrating synonyms of an electronic medical record; and

FIG. 22 is a diagram illustrating a re-search screen.

### DESCRIPTION OF THE PREFERRED EMBODIMENTS

For example, when a call for papers is issued by a society to hold an academic meeting, a number of papers are sent before the meeting. The compilers of the academic meeting have to properly perform clustering (classification) on a number of sent papers to a plurality of sessions and prepare a program. Along the sessions to which the papers are classified and the prepared program, attributes are given to data indicative of a paper (paper data). By registering the paper data in a database of an information retrieval system, the database of the paper data can be grown.

In the compiling work of registering the paper data into the database, first, a compiler has to classify papers on the basis of the titles, the abstracts, keywords, and the like of papers, which are given by the authors of the papers.

However, the way of employing the keywords and technical terms varies among the authors of papers. Therefore, in the case where there are a number of paper data pieces to be classified, if the compiling work is performed depending on only the knowledge of the compiler, it is not easy to categorize keywords and technical terms and the complier finds the compiling work difficult.

Such a problem occurs not only in the case of classifying papers but also generally in the case of classifying various contents.

An information retrieval system 1A according to a preferred embodiment of the present invention uses, to facilitate a compiling work of adding new contents to a database to be searched in, the technique proposed in Japanese Patent Application Laid-Open No. 2004-234404. The technique relates to an information retrieval system in which a logic model expressing a logic guide in a searching process is always developed in response to a request for the searching process by the user.

In the case of expressing the relation between a search request “x” and a search output “y” as y=f(x), a function form of y=f(x) or a rule for deriving the function form, which is held as a model is the logic model. The expression of “development of the logic model” indicates that the relation of a search output to a search request is changed while the intention of the user is reflected, and includes general development of the searching function in which the intention of the user is reflected. The basic concept of development of the logic model in the information retrieval system 1A is similar to that described in Japanese Patent Application Laid-Open No. 2004-234404.

The information retrieval system 1A according to the preferred embodiment of the present invention will be described below with reference to the drawings.

Outline of Information Retrieval System

The information retrieval system 1A extracts a search keyword group from a query of a natural sentence and uses it for a searching process. The information retrieval system 1A includes both a search result of the searching process and the search keyword group used for obtaining the search result on a single graphical user interface (GUI) screen. Since the user (operator of the information retrieval system 1A) can recognize both of a search result and a search keyword group used for obtaining the search result, the user can easily determine the satisfaction level for the search result by the extracted search keyword group. Therefore, in the information retrieval system 1A, the user can easily determine a guide for changing the search keyword group for obtaining a search result with higher satisfaction level. In the specification, the “search keyword group” indicates a set of a plurality of search keywords or a single search keyword, and the “satisfaction level” is a level for evaluating appropriateness and usefulness depending on the user, among compatibility, appropriateness, and usefulness as main indices on effectiveness of a search result.

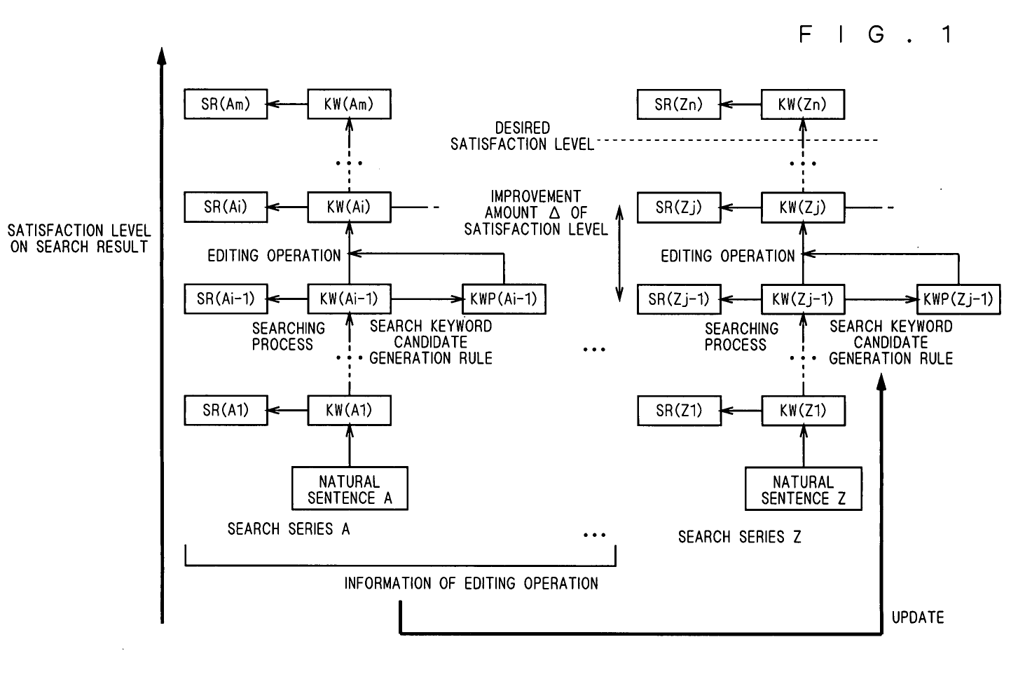

The information search system 1A has a function of supporting a change in a search keyword group for improving the satisfaction level on a search result (hereinafter, also simply referred to as “search supporting function”). In the following, the search supporting function will be described with reference to FIG. 1. FIG. 1 is a diagram schematically showing improvement in the satisfaction level by the search supporting function.

First Search Supporting Function

In a search series A, the user changes a search keyword group like KW(A1)→ . . . →KW(Ai−1)→KW(Ai)→ . . . →KW(Am). The search keyword group is changed so as to improve the user's satisfaction level on search results SR(A1), . . . , SR(Ai−1), SR(Ai), . . . for the group of search keywords KW(A1), . . . , KW(Ai−1), KW(Ai), . . . , respectively.

A first search supporting function in the information retrieval system 1A is a function of supporting the changes of KW(A1)→ . . . →KW(Ai−1)→KW(Ai)→ . . . →KW(Am) in the search keyword group in the search series A. In a conventional information retrieval system, to change the search keyword group in order to improve the satisfaction level, the user is forced to change it in a trial-and-error manner with complicated manual input operation. In the information retrieval system 1A, the search keyword group KW(Ai) used for obtaining the search result SR(Ai) can be generated by performing an editing operation on the search keyword group KW(Ai−1) immediately preceding the search keyword group KW(Ai). An example of the editing operation is an editing operation of adding an arbitrary keyword by the user. By the editing operation, the intention of the user can be easily reflected in the search keyword group KW(Ai). Thus, the change of the search keyword group from KW(Ai−1) to KW(Ai) for improving the user's satisfaction level on the search result SR(Ai) can be easily executed.

Second Search Supporting Function

A second search supporting function in the information retrieval system 1A is a function of storing information of editing operations in a past search series A, . . . and using the stored information for a present search series Z. Since the information of the editing operation is a record of an expression of intension of the user, the second search supporting function is also a function of optimizing navigation of the search series Z by using the expression of intention of the user in the past.

Also in the search series Z, the user changes the search keyword group like KW(Z1)→ . . . →KW(Zj−1)→KW(Zj)→ . . . →KW(Zn). In the search series Z, for generation of a search keyword candidate KWP(Zj−1), information of the editing operations in the past search series A, . . . is used. Specifically, in the information search system 1A, a search keyword candidate generating rule for generating a search keyword candidate KWP(Zj−1) from the search keyword group KW(Zj−1) is updated on the basis of the information of the editing operations in the past search series A, Consequently, the more the information of the editing operations is accumulated in the information retrieval system 1A, the information retrieval system 1A can generate a search keyword candidate KWP(Zj−1) more properly, so that the user can change the search keyword group more properly. Further, the more the experience of the editing operation is accumulated in the information retrieval system 1A, an improvement amount Δ of the satisfaction level by a change in the search keyword group increases, and the user can reach a search result at desired satisfaction level by a smaller number “n” of search times. Concrete examples of use of information of the editing operations are as follows.

(1) An arbitrary search keyword added by the user in the past is preliminarily included in the search keyword candidate KWP(Zj−1).

(2) A search keyword which was not added so much in the past is preliminarily removed from the search keyword candidate KWP(Zj−1).

Further, the information search system 1A has the function of supporting a data editing work (hereinafter, also simply referred to as “editing supporting function”) such as classification and registration of a new data group at the time of performing a work (editing work) of newly registering a data group obtained by converting a plurality of pieces of information into an electronic form to a data group obtained by converting a number of pieces of information to be subjected to the searching process into an electronic form. By the editing supporting function, the editing work of adding new contents to the information retrieval system 1A can be facilitated.

The configuration of the information retrieval system 1A for realizing the editing supporting function will be described below.

Configuration of Information Retrieval System

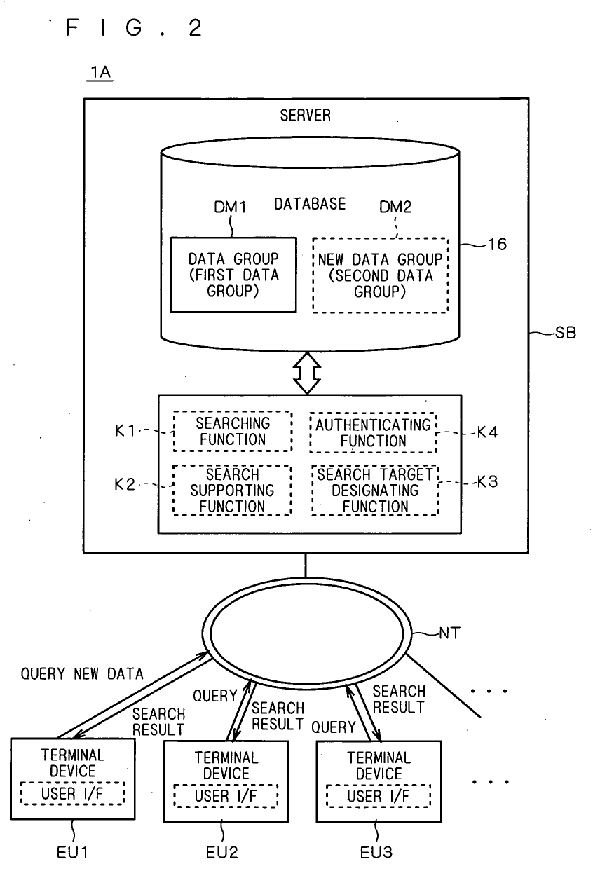

FIG. 2 is a diagram showing main components of the information retrieval system 1A having the editing supporting function.

As shown in FIG. 2, the information retrieval system 1A is constructed by connecting a server SB storing a database and a plurality of terminal devices including terminal devices EU1 to EU3 via communication lines NT. Each of the server SB and the plurality of terminal devices is constructed by a personal computer or the like. For example, the server SB stores a database 16 in a storage such as a hard disk and includes a CPU realizing various functions and controls by reading and executing a program or the like stored in a storage or the like. Each of the terminal devices EU1 to EU3 has an user interface (I/F) including various operation units and a display.

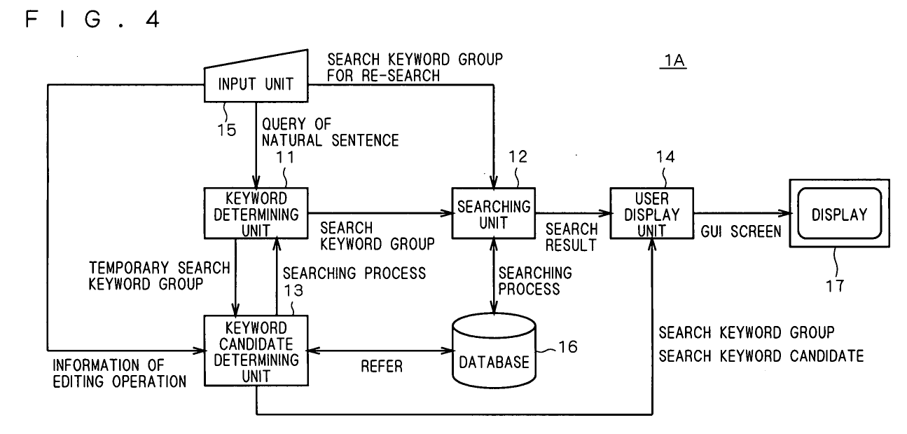

As shown in FIG. 2, in the information retrieval system 1A, like a conventional information retrieval system, a data group (first data group) DM1 to be retrieved is stored in the database 16. For example, when a search condition (query) is entered by an user operation on the user I/F of the terminal device EU1, a search request corresponding to the query is transmitted to the server SB via the communication line NT. In the server SB, in response to the search request, a searching process directed to the first data group DM1 prestored in the database 16 is performed by a searching function K1. The terminal device EU1 obtains data indicative of a result of the searching process from the server SB, and the result of the searching process is visibly output to a display 17 (FIG. 4) included in the user I/F of the terminal device EU1. Similar searching processes can be performed from other terminal devices such as the terminal devices EU2 and EU3.

In the conventional information retrieval system, only after a work (editing work) of properly classifying a new data group and entering it to the first data group DM1, the searching process can be performed on the new data group.

In contrast, in the information search system 1A, a new data group (second data group) DM2 to be entered to the first data group DM1 can be added to (temporarily registered in) the database 16 so as to be distinguished from the first data group DM1. As a method of storing the first and second data groups DM1 and DM2 so as to be distinguished from each other in the database 16, a method of storing the first and second data groups DM1 and DM2 into different folders can be employed.

The information retrieval system 1A has an editing supporting function of enabling the searching function K1 to be used also for the second data group DM2 in a state where the second data group DM2 is temporarily registered in the database 16 (also referred to as “editing work state”).

For example, in a state where the second data group DM2 is temporarily registered in the database 16 by the terminal device EU1 and the editing work state is obtained, when a query is entered by a user operation on the user I/F of the terminal device EU1, a search request corresponding to the query is sent to the server SB via the communication line NT. In the server SB, in response to the search request, the searching process on the second data group DM2 stored in the database 16 is performed by the searching function K1. The terminal device EU1 obtains data indicative of the result of the searching process from the server SB, and a result of the searching process is visibly output to the display 17 (FIG. 4) included in the user I/F of the terminal device EU1.

The information retrieval system 1A also has a search supporting function K2 described above. The search supporting function K2 can be utilized while the editing supporting function is being used.

The edition supporting function is provided with a function (search object designating function) K3 capable of selectively setting a data group to be retrieved from the first and second data groups DM1 and DM2 in response to the operation from the user I/F. The data group to be retrieved can be designated, for example, by designating one of two folders in which the first and second data groups DM1 and DM2 are stored.

With reference to a search result of the searching process on each of the first and second data groups DM1 and DM2, which is output to the user I/F, the user can efficiently perform the work of classifying the contents of the second data group DM2.

In FIG. 2, the information retrieval system 1A is constructed by the server SB and the plurality of terminal devices EU1 to EU3. Alternatively, the information retrieval system 1A may be constructed by a single computer, and operation units, a display, and the like included in the computer may be a user I/F.

If all of users can use the searching function K1 on the second data group DM2 to be edited, a situation that confusion occurs in the search result is caused. Therefore, it is preferable that only a data compiler as a specific user who compiles the second data group DM2 be permitted to use the editing supporting function. Methods of limiting a person who can use the editing supporting function include authentication of a specific user by entry of authentication information such as password or user ID and limitation of a terminal device in which the editing supporting function can be used by filtering using an IP address. The “specific user” subsumes a collection of single users and a plurality of users.

In the information search system 1A, a terminal device to which predetermined authentication information is entered is permitted to use the editing supporting function capable of performing the searching process also on the second data group DM2 by an authenticating function K4. For example, when a data editor as a specific user properly operates the user I/F of the terminal device EU1 to enter predetermined authentication information, the terminal device EU1 is permitted to use the editing supporting function by the authentication function K4.

By various operation of the user on the user I/F, new data (that is, the second data group) to be edited can be added to (temporarily registered in) the database 16 from the terminal device permitted to use the editing supporting function.

Although the editing supporting function has been mainly described above, in the following the configuration for realizing the searching function K1 and the search supporting function K2 used in the editing supporting function will be described.

Configuration Related to Searching Function and Search Supporting Function

The information retrieval system 1A executes the searching process on a data group to be searched for, extracts a matched data group which matches the search keyword group, and presents the matched data group to the user. The data group to be searched is not limited but any data group obtained by converting information in the academic field, the industrial field, and the life field into an electronic form can be used as the data group to be searched. Examples of the information in the academic field are various documents, technical reports, papers, patent information, and the like. Examples of the information in the industrial field are commodity information and shop information. Examples of the information in the life field are local information and food information. In the following description, as the data group to be searched of the information retrieval system 1A, a data group obtained by converting papers in the medical field into an electronic form is used.

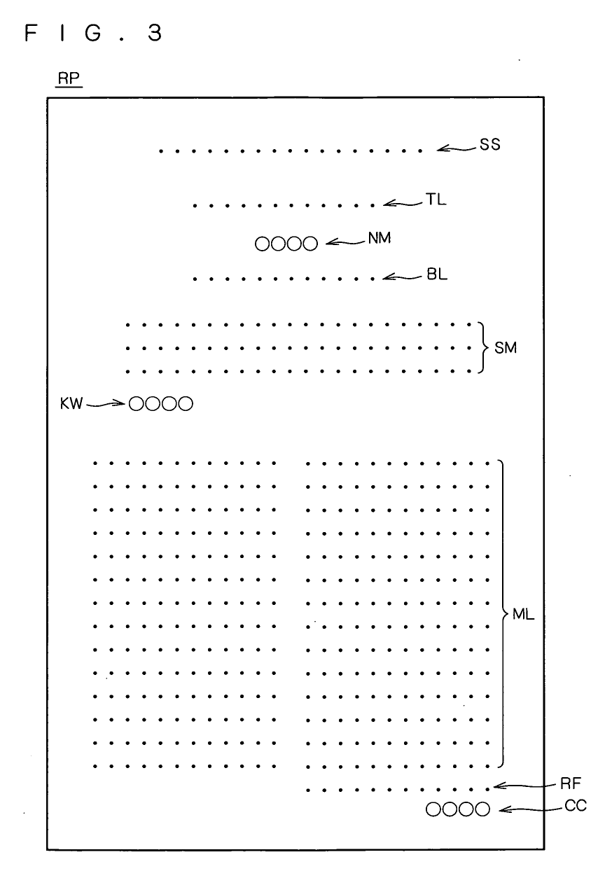

FIG. 3 is a diagram illustrating a paper RP in the medical field, which is stored in the data group to be searched. The paper RP includes, from the top, a session name SS, a title TL, an author NM, an organization BL to which the author belongs, an abstract SM, a keyword KW, a body ML, a reference RF, and the number CC of a meeting are described. In the description, the session name SS is the name of a session to which the paper RP is classified in the meeting of a society. The number CC of the meeting is the number of the meeting to which the paper RP is entered. The session name SS and the number CC of the meeting are given by the data editor after papers sent from authors are properly classified.

FIG. 4 is a block diagram showing the configuration related to the searching function and the search supporting function of the information retrieval system 1A. The information retrieval system 1A has function blocks such as a keyword determining unit 11, a searching unit 12, a keyword candidate determining unit 13, and a user display unit 14. The information retrieval system 1A is constructed by a plurality of computers connected so as to be able to perform communications (hereinafter, they may be also simply generically referred to as “computers”). The function blocks are expressions of functions realized when the computer executes an information retrieving program.

The keyword determining unit 11 extracts a search keyword group used for the searching process from a query of a natural sentence entered by the user and outputs it to the searching unit 12. The extraction is performed by conducting a language analysis on the natural sentence. In the information retrieval system 1A, dependency structure analysis, morphological analysis, or the like is used as the language analysis. The dependency structure analysis is an analysis of decomposing a sentence to clauses and specifying the dependency among the decomposed clauses. The morphological analysis is an analysis of dividing a sentence to words. By providing the information retrieval system 1A with the keyword determining unit 11, only by entering a query of a natural sentence, the user can make the information retrieval system 1A execute the searching process. Consequently, even a user who does not have a skill to determine a search keyword group can make the information retrieval system 1A execute the searching process.

The searching unit 12 executes the searching process of obtaining a search result by using the search keyword group. The searching unit 12 executes the searching process in response to a search keyword group for the first search from the keyword determining unit 11 or a search keyword group for re-search from an input unit 15, and outputs a search result on the search keyword group to the user display unit 14. The functions of the searching unit 12 are realized by a full text search engine and a metadata search engine (in the following, they may be also simply generically referred to as “search engine”).

The search target of each of the full text search engine and the metadata search engine is the whole paper and a designated range. The search engines extract a matched data group matching a given search keyword group from the data group to be searched. The searching unit 12 outputs information related to the matched data group as a search result. The function of the searching unit 12 may be realized by a concept search engine or the like.

The data group to be searched by the searching unit 12 is stored in the database 16. The database 16 is realized by using a storage provided for the computer. The “data group to be searched” corresponds to the first data group DM1 or the second data group DM2 when the editing supporting function is being used, and corresponds to the first data group DM1 when the editing supporting function is not being used.

Preferably, the data format of the data group to be searched is, although not limited, a tagged document marked with a tag. As a description language used for describing a tagged document, SGML (Standard Generalized Markup Language), XML (eXtenbile Markup Language), HTML (HyperText Markup Language), XHTML (extensible HyperText Markup Language), RDF (Resource Description Framework), or the like can be employed. As the structure of the database 16, any of a relational structure, a structure in which a document described in any of the description languages is stored relationally, and a native XML structure can be employed. In the following description, it is assumed that the data group to be searched is structured with the RDF.

The keyword candidate determining unit 13 generates a search keyword candidate from a search keyword group on the basis of the search keyword generation rule, and outputs the search keyword candidate together with the search keyword group to the user display unit 14. To the search keyword candidate, relation information as information of the relation to a search keyword included in the search keyword group and display order information as information indicative of the display order on a re-search screen which will be described later is also added.

Further, the keyword candidate determining unit 13 has the function of helping generation of the search keyword group by the keyword determining unit 11. That is, the keyword candidate determining unit 13 has the function of converting a temporary search keyword group generated by the keyword determining unit 11 to a search keyword group which is actually used for the searching process. During the process, the keyword candidate determining unit 13 refers to the data group to be searched which is stored in the database 16. The keyword candidate determining unit 13 stores information of the editing operation and updates the search keyword generation rule.

The user display unit 14 generates GUI screens such as a first search screen, a re-search screen, and a co-author relation screen and outputs them to the display 17. The first search screen is a GUI screen providing the function of entering a query of a natural sentence. The user can enter a query to the information retrieval system 1A by performing a predetermined GUI operation by using the input unit 15 on the first search screen. On the re-search screen, a search result and the search keyword group used for obtaining the search result are simultaneously displayed.

Further, the search keyword candidate is also displayed on the re-search screen. The display layout of the search keyword candidate on the re-search screen is determined on the basis of the relation information and the display order information. On the re-search screen, the user can generate a search keyword group for re-search from the search keyword group used for the immediately preceding searching process by performing a predetermined GUI operation (editing operation) with the input unit 15. The co-author relation screen is a screen illustrating joint works of the author of the paper. The GUI screens are displayed on the display 17 by execution of a program in, for example, HTML or JAVA (trademark) applet using a browser.

The input unit 15 is means including input devices such as a keyboard and a pointing device for entering information to the information retrieval system 1A by the user, and is included in a user I/F of a terminal device or the like. The display 17 is also included in the user I/F of the terminal device.

The detailed functional configuration of the keyword determining unit 11 and the keyword candidate determining unit 13 will be sequentially described.

Keyword Determining Unit

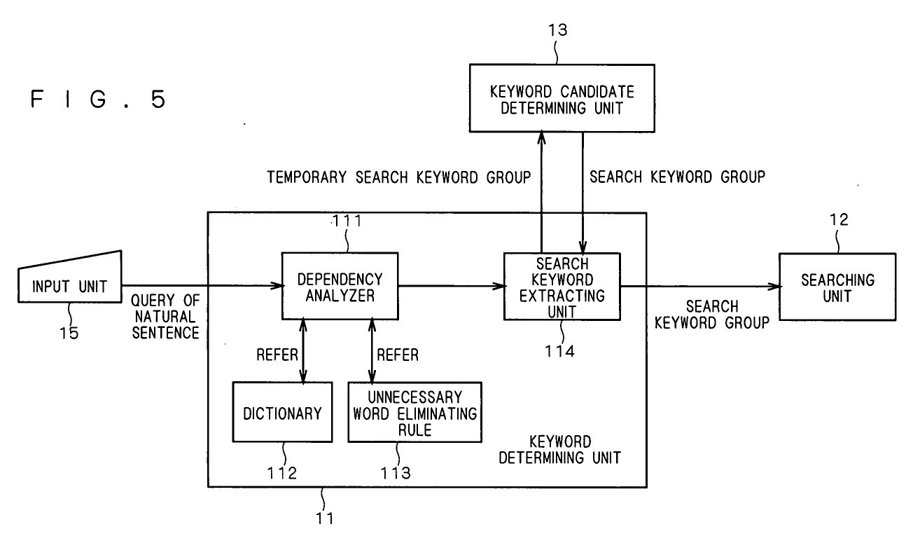

FIG. 5 is a block diagram showing a detailed functional configuration of the keyword determining unit 11. In the following description, the case where a Japanese natural sentence of “DENSIKARUTEOFUKUMURONBUN in paper” is entered as a query will be used as a proper example. In the present specification, Roman letters in capitals represent sentences, phrases or words in Japanese. It is assumed that, in the case where a query includes a clause “in paper”, in the information retrieval system 1A, the full text search engine is used for the searching process and the clause indicating that the whole paper lies in the search range is ignored in language processing.

A query entered to the keyword determining unit 11 is supplied to a dependency analyzer 111. The dependency analyzer 111 executes dependency analysis and morphological analysis of a natural sentence and decomposes the natural sentence into clauses (three clauses of “DENSIKARUTEO”, “FUKUMU”, “RONBUN”) and words (five words of “DENSI”, “KARUTE”, “O”, “FUKUMU”, and “RONBUN”) by referring to a dictionary 112. After that, the dependency analyzer 111 describes a decomposition result in an XML document. Further, the dependency analyzer 111 specifies words (“FUKUMU” and “RONBUN” whose document specification capability is low and a postpositional word “O” functioning as an auxiliary to a main word) which are unnecessary and inappropriate as search keywords in the decomposed words with reference to an unnecessary word eliminating rule 113.

A search keyword extracting unit 114 extracts the decomposed words excluding the unnecessary words (two words of “DENSI” and “KARUTE”) as a temporary search keyword group and outputs the words to the keyword candidate determining unit 13. Further, the search keyword extracting unit 114 outputs a search keyword group (a term of “DENSIKARUTE”) sent back from the keyword candidate determining unit 13 to the searching unit 12.

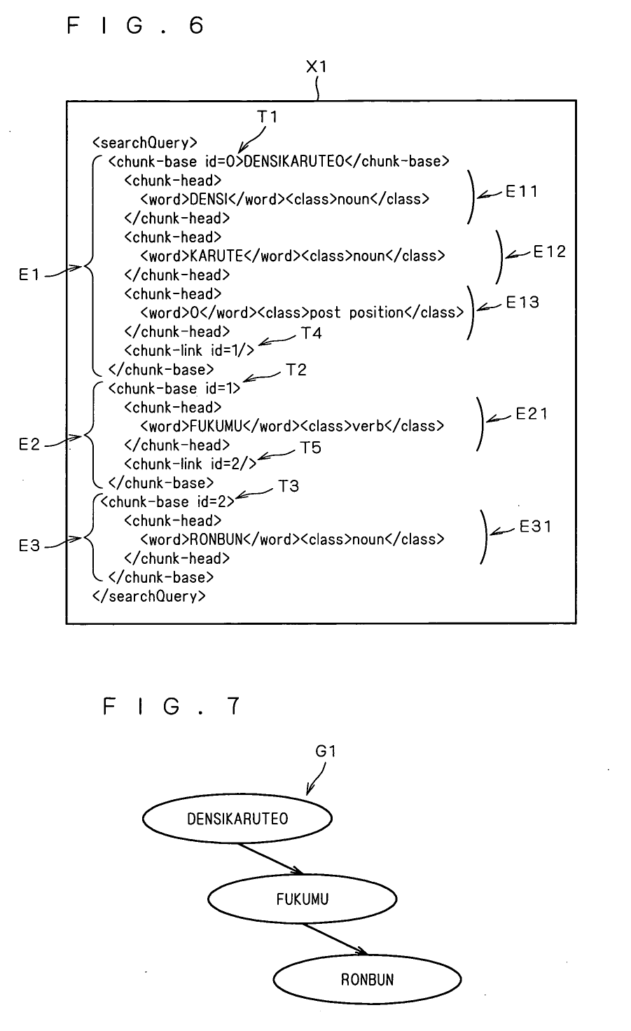

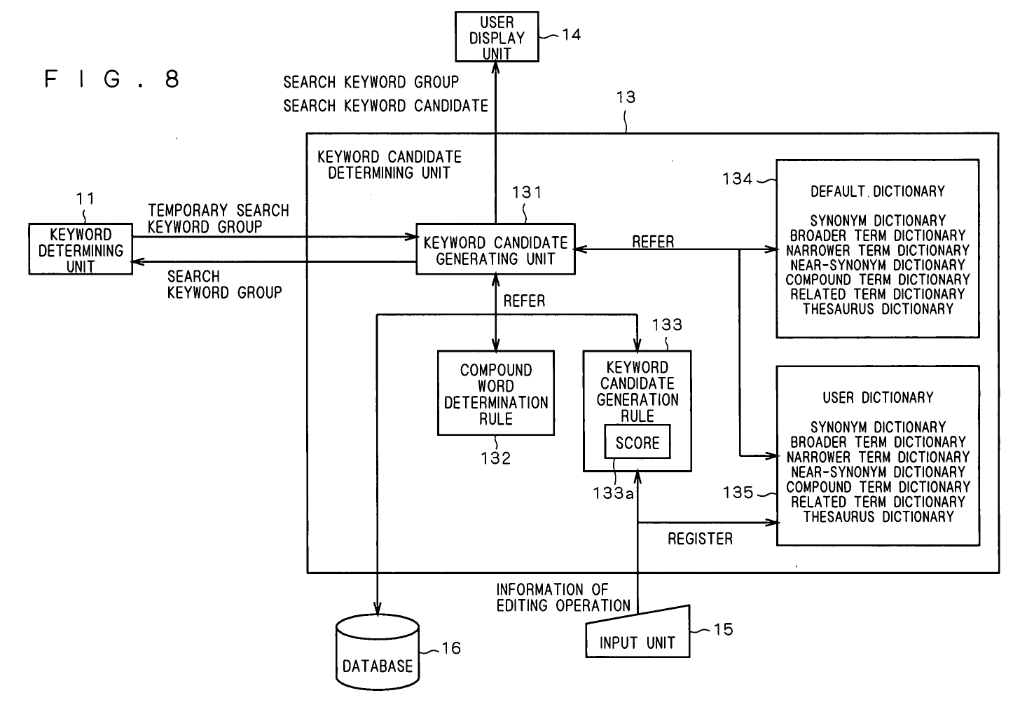

FIG. 6 illustrates an XML document describing the decomposition result. An XML document X1 includes elements E1 to E3 corresponding to three clauses of “DENSIKARUTEO”, “FUKUMU”, “RONBUN”. As shown in tags T1 to T3, IDs of 0, 1, and 2 are assigned to the elements E1, E2, and E3, respectively. As shown in tags T4 and T5, the IDs are used for expressing dependency among clauses schematically shown in a graph G1 of FIG. 7. The XML document X1 further includes, as child elements of the elements E1 to E3, elements E11 to E13, E21, and E31 corresponding to “DENSI”, “KARUTE”, “O”, “FUKUMU”, and “RONBUN” included in the clauses “DENSIKARUTEO”, “FUKUMU”, and “RONBUN” corresponding to the elements E1 to E3. In the elements E11 to E13, E21, and E31, concrete words (word elements) and their parts of speech (class elements) are described.

Keyword Candidate Determining Unit

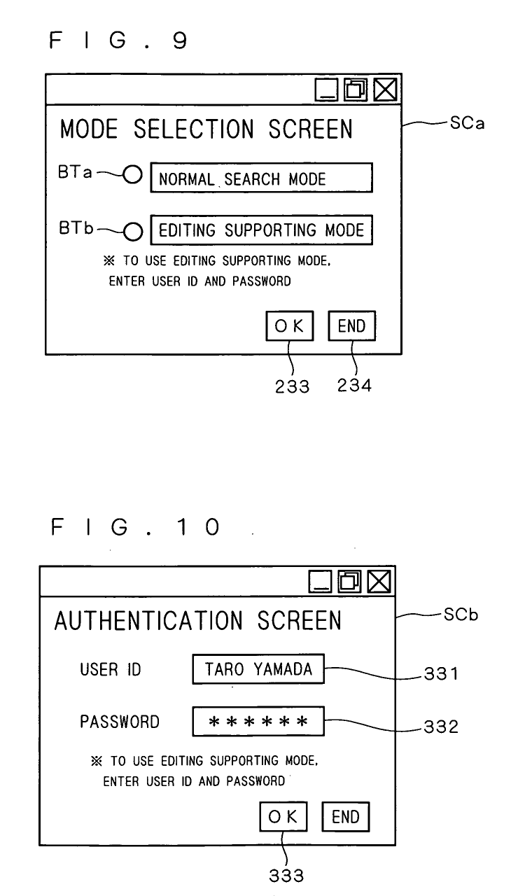

FIG. 8 is a block diagram showing a detailed functional configuration of the keyword candidate determining unit 13.

A keyword candidate generating unit 131 in the keyword candidate determining unit 13 has (a) a function of generating a search keyword group from a temporary search keyword group and (b) a function of generating a search keyword candidate from a search keyword group.

First, the function (a) of generating a search keyword group from a temporary search keyword group will be described. The temporary search keyword group entered to the keyword candidate determining unit 13 is supplied to a keyword candidate generating unit 131. The keyword candidate generating unit 131 generates a search keyword group from the temporary search keyword group on the basis of a compound word determination rule 132.

More concretely, the keyword candidate determining unit 13 determines whether a search keyword (word) obtained by decomposing a compound word is included in the temporary search keyword group or not. If the search keyword is included in the temporary search keyword group, the keyword candidate determining unit 13 replaces the search keyword with a search keyword of the compound word, thereby generating the search keyword group. The search keyword group is actually used for the searching process. The search keyword group is sent back to the keyword determining unit 11 and used for generating a search keyword candidate which will be described below.

As the compound word determination rule 132, although not limited, for example, a rule that “continuous nouns appearing in the same clause are dealt as a compound word” (for example, two continuous nouns of “DENSI” and “KARUTE” included in the clause “DENSIKARUTEO” are dealt as a compound word “DENSIKARUTE”) can be employed.

The function (b) of generating a search keyword candidate from a search keyword group will now be described. The keyword candidate generating unit 131 generates a search keyword candidate from a search keyword group on the basis of a keyword candidate generation rule 133. The search keyword group and the generated search keyword candidate are output to the user display unit 14. To the search keyword candidate, the relation information and the display order information is also added.

In the information retrieval system 1A, the search keyword candidates are synonym, broader term, narrower term, near-synonym, compound term, and related term of search keywords included in the search keyword group. Those are terms having predetermined relations with the search keywords and are keywords estimated to be desirably used by the user by replacing a search keyword included in the search keyword group or by being added to the search keyword group. A search keyword candidate is generated on the basis of the keyword candidate generation rule 133 with reference to default dictionaries held by default in the information retrieval system 1A and user dictionaries to which words can be registered by the user.

At the time of generating a compound term, the data group to be searched which is stored in the database 16 is also referred to. For example, in the case where the words “SINRYOUROKU” frequently appear in the data group to be searched, the keyword candidate generating unit 131 determines that words obtained by decomposing a compound term of “DENSISINRYOUROKU” are “DENSI” and “SINRYOUROKU”.

Further, the keyword candidate generating unit 131 has the function of changing a search keyword candidate to be generated in the case where the same search keyword groups are given. That is, the keyword candidate determining unit 13 can update the keyword candidate generation rule 133 as a rule of generating a search keyword candidate from a search keyword group. The updating is performed on the basis of the information of the editing operation.

More concretely, the keyword candidate generating unit 131 gives a predetermined score to a word used as a search keyword for re-search, and changes a search keyword candidate generated on the basis of a result of totaling the scores. A total score 133a is a record of the information of the editing operation and is a parameter for specifying the keyword candidate generation rule 133 in the keyword candidate generating unit 131. Consequently, the information retrieval system 1A can reflect the information of the editing operation performed in the past into the search keyword group for re-search and the re-search. Thus, in the information retrieval system 1A, it is easy to change a search keyword to improve the satisfaction level on a search result.

It is not hindered to store and use the information of the editing operation by other methods. The updating of the keyword candidate generation rule 133 based on the information of the editing operation may be performed in a real-time manner or at predetermined time intervals. Correction of the score 133a may be permitted to the administrator of the information retrieval system 1A.

GUI Screens

In the following, among screens generated by the user display unit 14, a mode selection screen SCa, an authentication screen SCb, a search target designation screen SCc, a first search screen SCd, re-search screens SC2 and SC3, a paper display screen SC4, and co-author relation screens SC5 to SC7 will be described with reference to screen examples.

Mode Selection Screen

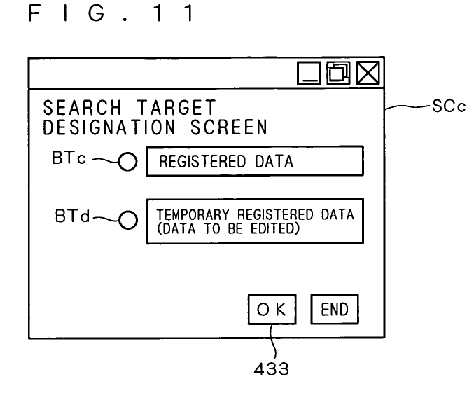

FIG. 9 is a diagram illustrating the mode selection screen SCa. The mode selection screen SCa is a screen for selectively setting a mode of performing a searching process (normal searching mode) on the first data group DM1 and a mode capable of using the editing supporting function (editing supporting mode).

On the mode selection screen SCa, search mode selection buttons BTa and BTb as two radio buttons which can be alternatively selected, an OK button 233, and an end button 234 are displayed. When the search mode selection button BTa is selected and the OK button 233 is clicked, the normal searching mode is selected. On the other hand, when the search mode selection button BTb is selected and the OK button 233 is clicked, the editing supporting mode is selected. When the editing supporting mode is selected, the authentication screen SCb is displayed on the display 17.

The user can finish the operation of the information retrieval system 1A by clicking the end button 234 (in the following examples of the screen display, the end button functions similarly).

Authentication Screen

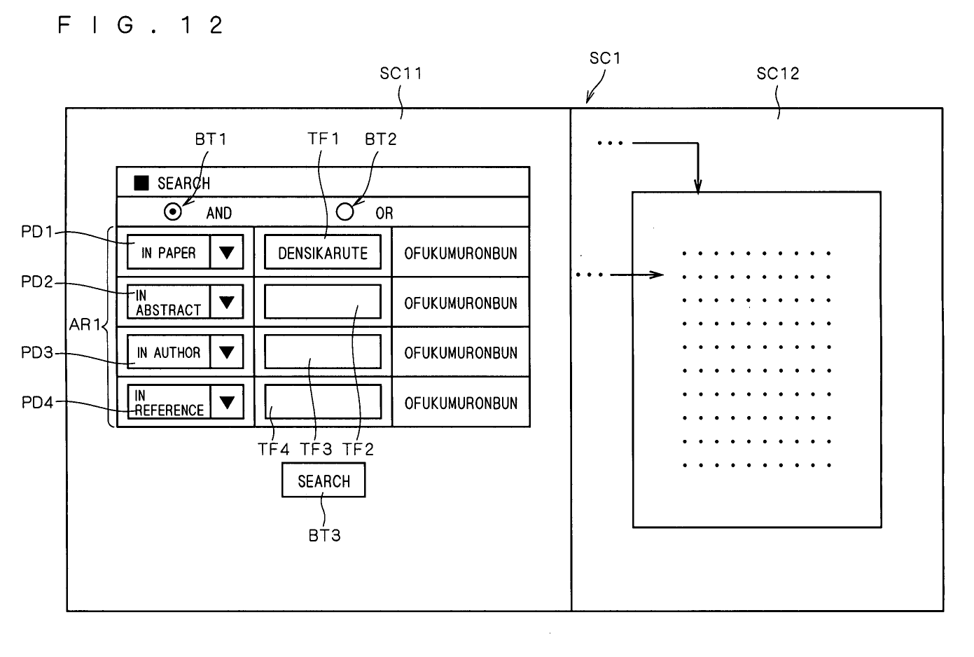

FIG. 10 is a diagram illustrating the authentication screen SCb. The authentication screen SCb is a screen for performing authentication to specify a data editor who can use the editing supporting function. On the authentication screen SCb, a user ID box 331, a password box 332, an OK button 333, and an end button are displayed.

When the user enters user ID and password to the user ID box 331 and the password box 332 and clicks the OK button 333, in the case where the entered user ID and password coincide with user ID and password preliminarily registered in the information retrieval system 1A, the authenticating process is completed and the user can use the editing supporting function. When the editing supporting function is enabled, the search target designation screen SCc is displayed on the display 17.

Search Target Designation Screen

FIG. 11 is a diagram illustrating the search target designation screen SCc. The search target designation screen Scc is a screen for alternatively designating, as a search target, one of the first and second data groups DM1 and DM2.

On the search target designation screen SCc, search target designation buttons BTc and BTd as two radio buttons which can be alternatively selected, an OK button 433, and an end button are displayed. When the search target designation button BTc is selected and the OK button 433 is clicked, registration data, that is, the first data group DM1 is designated as a search target. On the other hand, when the search target designation button BTd is selected and the OK button 433 is clicked, temporary registration data, that is, the second data group DM2 is designated as a search target. When the search target is designated as described above, the first search screen SC1 is displayed on the display 17.

First Search Screen

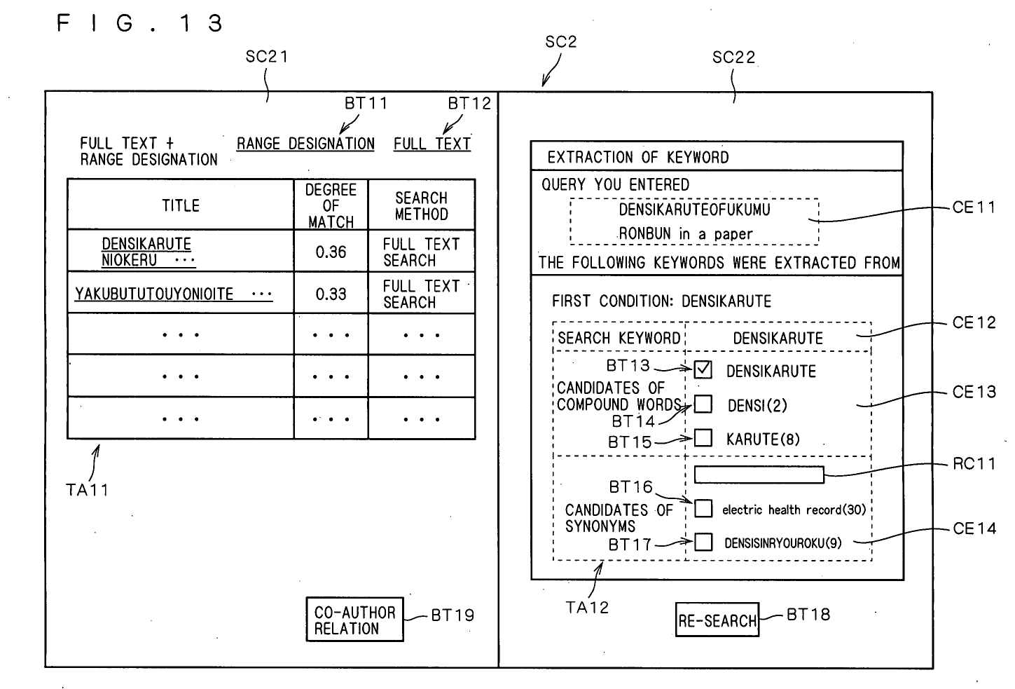

FIG. 12 is a diagram illustrating the first search screen SC1. The first search screen SC1 is a composite screen constructed by a search condition entry screen SC11 on the left side and a help screen SC12 on the right side.

The search condition entry screen SC11 has the function of supporting entry of a query of a natural sentence. On the search condition entry screen SC11, search condition selection buttons BT1 and BT2 as two radio buttons which can be alternatively selected are displayed. In the case where the search condition selection button BT1 is selected, the information retrieval system 1A creates a query by obtaining AND of a plurality of individual queries. On the other hand, when the search condition selection button BT2 is selected, the information retrieval system 1A creates a query by obtaining OR of a plurality of individual queries.

Below the search condition selection buttons BT1 and BT2, a query input area AR1 is displayed. The query input area AR1 is provided with pull-down menus PD1 to PD4 for entering individual queries. In the pull-down menus PD1 to PD4, one of options of “in paper”, “in abstract”, “in author”, and “in reference” can be selected. The options correspond to search targets. Specifically, in the information retrieval system 1A, when “in paper”, “in abstract”, “in author”, or “in reference” is selected by using the pull-down menus PD1 to PD4, the corresponding part which is the whole paper, abstract of a paper, author in a paper, or a reference of a paper becomes a search target.

On the right side of the pull-down menus PD1 to PD4, text fields TF1 to TF4 are displayed, respectively. An arbitrary character line can be entered in the text fields TF1 to TF4.

The user can create a query by selecting an option in one of the pull-down menus and entering a character line in the text field on the right side of the selected pull-down menu. For example, when the option of “in paper” is selected in the pull-down menu PD1 and “DENSIKARUTE” is entered in the text field TF1, an individual query of “DENSIKARUTEOFUKUMURONBUN in paper” is created. On the first search screen SC1 of FIG. 12, four individual queries can be generated.

Below the query input area AR1, a search button BT3 is displayed. When click on the search button BT3 is detected, the information retrieval system 1A generates a query from individual queries and starts the searching process. After that, the re-search screen SC2 is displayed on the display 17.

The help screen SC12 is used for explaining the method of using the information retrieval system 1A.

Re-Search Screen

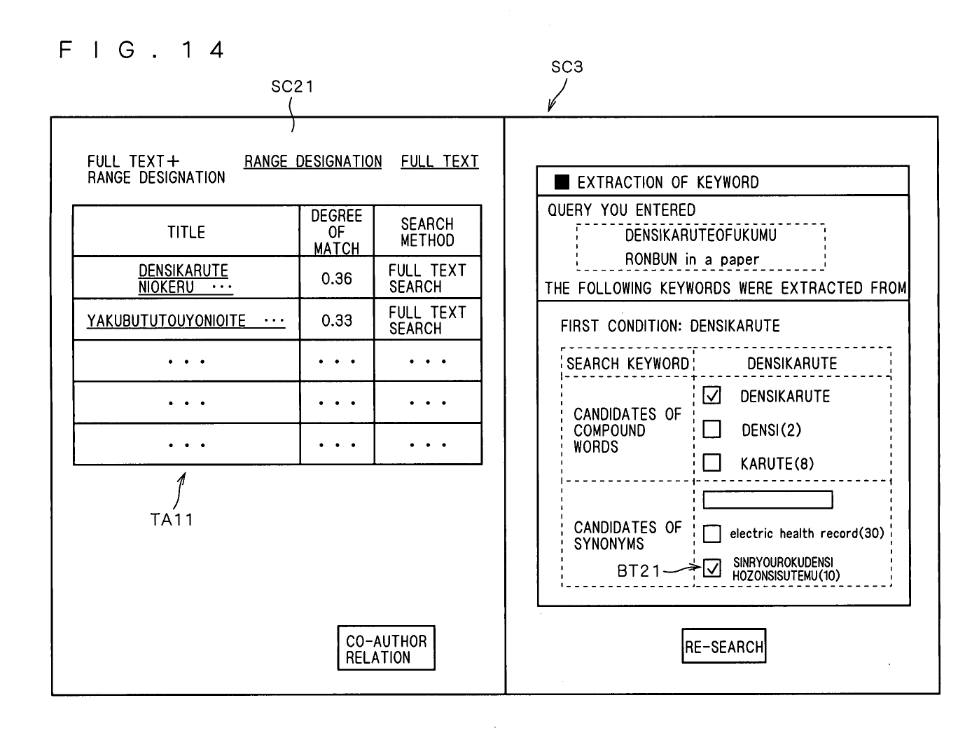

FIG. 13 is a diagram illustrating the re-search screen SC2. The re-search screen SC2 is a composite screen constructed by a search result display screen SC21 on the left side and a keyword candidate display screen SC22 on the right side.

On the search result display screen SC21, a search result general display table TA11 is displayed. On the search result general display table TA11, search results of both of the full text search engine and the metadata search engine are displayed. The search results of only the full text search engine or the metadata search engine are viewed by clicking on a range designation cancel button BT12 or a range designation limit button BT11. In each of rows in the search result general display table TA11, the title of an extracted paper, the degree of match, and search method are displayed.

The degree of match is a numerical value indicating the degree that the search keyword characterizes the contents of a paper. In this case, the search keyword is not a general term and, the more the search keyword appears in a paper, the higher the numerical value of the degree of match becomes. For example, by using the TFIDF or the like in a search with each of the full text search engine and the metadata search engine, the degree of match can be calculated.

The titles of papers are listed in the search result general display table TA11 in order of decreasing degree of match.

On the search result display screen SC21, when a co-author relation button BT19 displayed below the search result general display table TA11 is clicked, a screen illustrating joint works of the author of the paper (co-author relation screen) with respect to the search keyword group used for obtaining a search result is displayed on the display 17. A concrete mode of the co-author relation screen will be described later.

On the keyword candidate display screen SC22, a query display cell CE11 is displayed. In the query display cell CE11, the query entered on the first search screen SC1 is displayed.

Below the query display cell CE11, a keyword candidate display table TA12 is displayed. FIG. 13 shows the keyword candidate display table TA12 in the case where the search keyword is a term of “DENSIKARUTE”. Since the keyword candidate display table is provided for each search keyword, in the case where there are a plurality of search keywords, a plurality of keyword candidate display tables are displayed.

In a search keyword display cell CE12 on the right side of the first row in the keyword candidate display table TA12, a search keyword (“DENSIKARUTE”) is displayed. In the second row and subsequent rows of the keyword candidate display table TA12, search keyword candidates are displayed collectively in relation with a search keyword. FIG. 13 shows a state in which keyword candidates as compound terms and synonyms are displayed. Alternately, any of the above-described synonym, broader term, narrower term, near-synonym, compound term, and related term can be displayed.

In a compound term candidate display cell CE13, in addition to “DENSIKARUTE” as a search keyword, “DENSI” and “KARUTE” as words obtained by decomposing the “DENSIKARUTE” are displayed. Selection buttons (check boxes) BT13 to BT15 are displayed at the head of the character lines of “DENSIKARUTE”, “DENSI”, and “KARUTE”, respectively. In a default state of the keyword candidate display screen SC22, the selection button BT13 corresponding to “DENSIKARUTE” as the search keyword used for immediately preceding searching process is selected (marked with the check box).

Further, in a synonym candidate display cell CE14, a synonym registration box RC11 and “electronic health record” and “DENSISINRYOUROKU” as synonyms of the “DENSIKARUTE” as the search keyword are displayed. Selection buttons BT16 and BT17 are also displayed at the head of the character trains of “electronic health record” and “DENSISINRYOUROKU”, respectively.

On the right side of the words displayed in the compound term candidate display cell CE13 and the synonym candidate display cell CE14, scores indicative of the degree that the words of the compound term and synonyms are supported as the words and synonyms of the search keyword are displayed. The scores will be described later.

Operation of editing a search keyword group on the keyword candidate display area SC22 will now be described. Any of the search keyword group and the search keyword candidate can be used as a search keyword for re-search by selecting the selection button at the head. By canceling selection of a selection button already selected, a search keyword corresponding to the selection button can be excluded from the search keyword group for re-search. Further, a word or a term entered to the synonym registration box RC11 can be used as an additional search keyword for re-search. By entering a word or a term to the synonym registration box RC11 and re-executing the searching process, the word or the term is registered to a user dictionary 135.

In the keyword candidate display screen SC22, by clicking a re-search button BT18 displayed below the keyword candidate display table TA12, the information retrieval system 1A is permitted to execute the searching process using a search keyword group for re-search obtained by the editing operation. That is, the keyword candidate display screen SC22 is a screen for generating a re-search keyword group from the search keyword group by the editing operation.

When the re-search button BT18 is clicked on the keyword candidate display screen SC22, an updated re-search screen is displayed on the display 17. On the search result display screen of the re-search screen, the result of search with the search keyword for re-search is displayed. On the keyword candidate display screen, new keyword candidates are displayed.

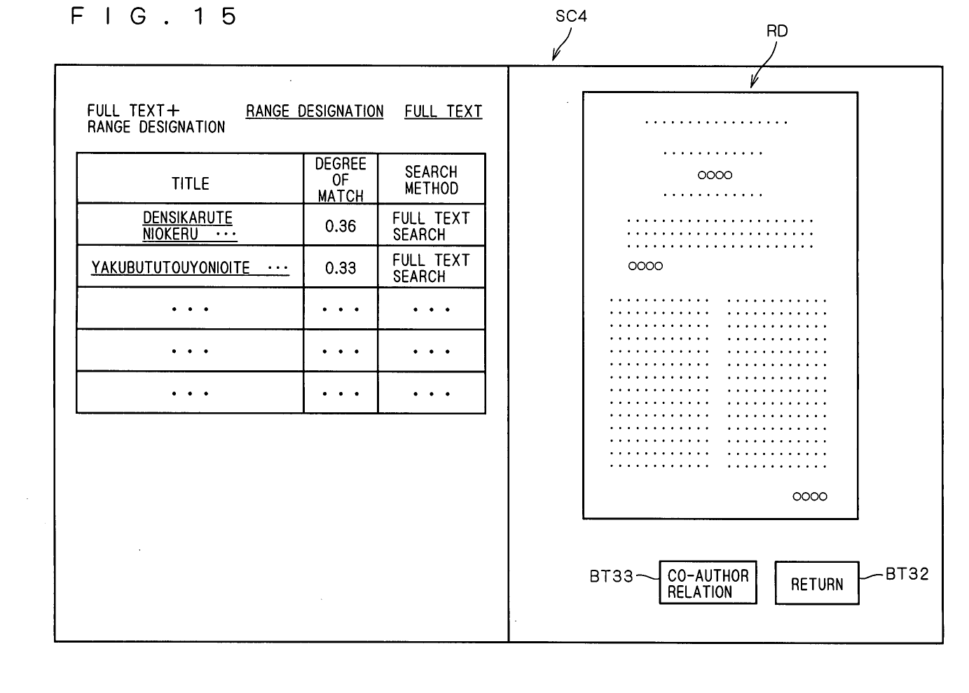

For example, FIG. 14 shows a new re-search screen SC3 after re-search in the case where a new search keyword “SINRYOUROKUDENSIHOZONSISUTEMU” is entered in a synonym registration box RC11. On the re-search screen SC3, “SINRYOUROKUDENSIHOZONSISUTEMU” registered in a user dictionary is newly displayed as a synonym, and a selection button BT21 is marked, thereby indicating that the term is actually used for re-search. As described above, in the preferred embodiment, by adding and registering such a synonym, a logic model expressing logical guide in the searching process is updated, and the logic model is developed.

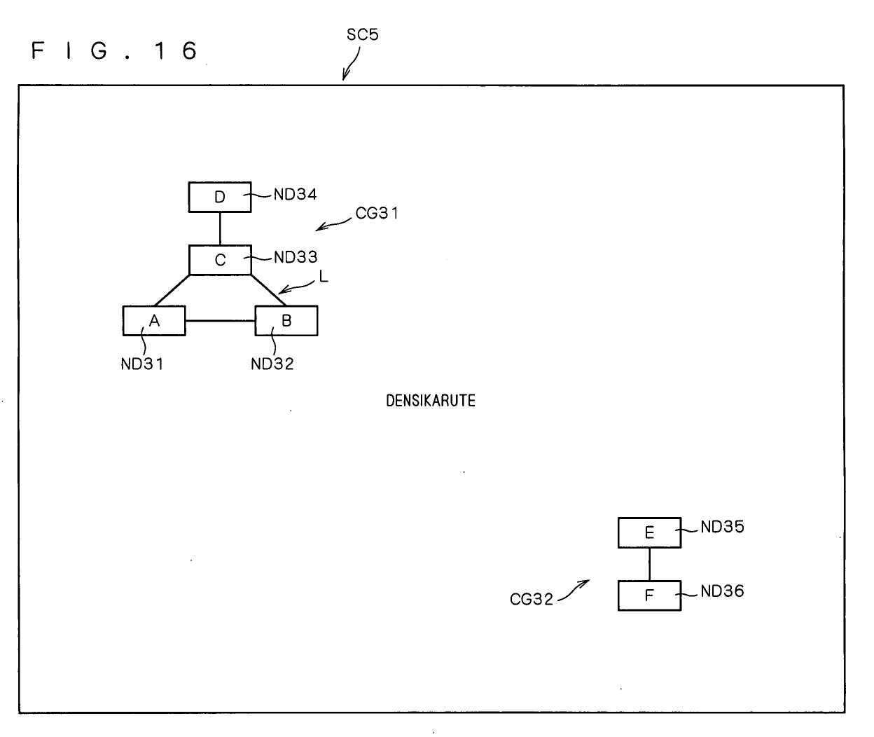

The titles of papers listed in the search result general display table TA11 are associated with actual paper data by hyperlink. Therefore, by adjusting a mouse pointer (not shown) onto the title of a desired paper and double clicking the mouse, for example, the paper display screen SC4 (FIG. 15) on which paper data is visibly output can be displayed on the display 17.

On the paper display screen SC4, for example, the screen on the right side of the re-search screen SC3 shown in FIG. 14 is changed to a screen (paper display screen) RD on which paper data is visibly output. By clicking a return button BT32 displayed below the paper display screen RD, a screen displayed on the display 17 can be reset to a screen displayed just before (for example, the re-search screen SC3).

By clicking a co-author button BT33 displayed below the paper display screen RD, a co-author relation screen illustrating joint works of the author of the paper whose paper data is output on the paper display screen RD is displayed on the display 17.

The co-author relation screen will be described below.

Co-Author Relation Screen

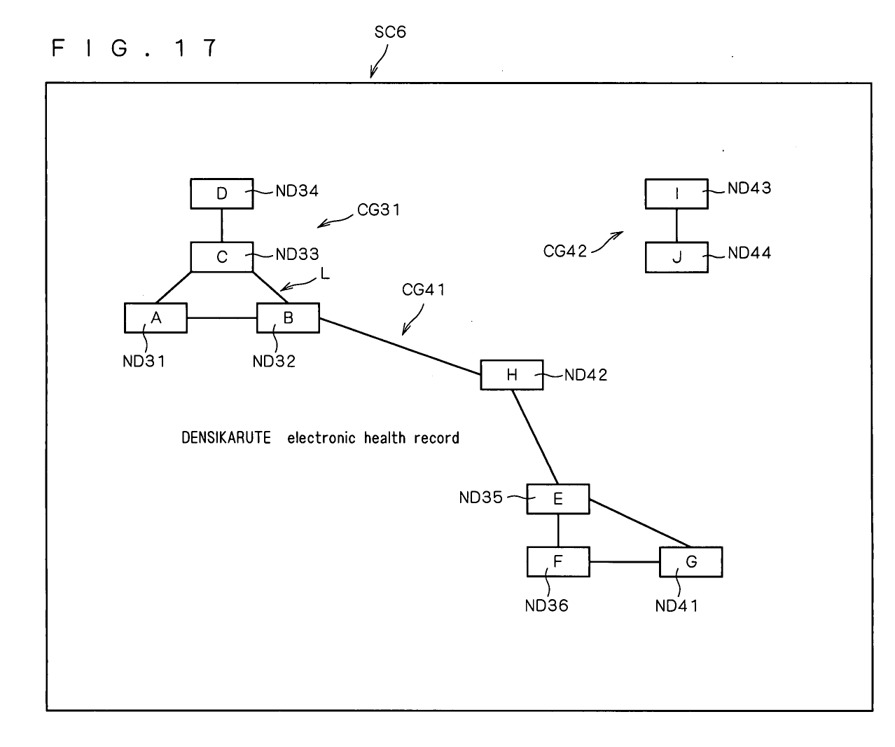

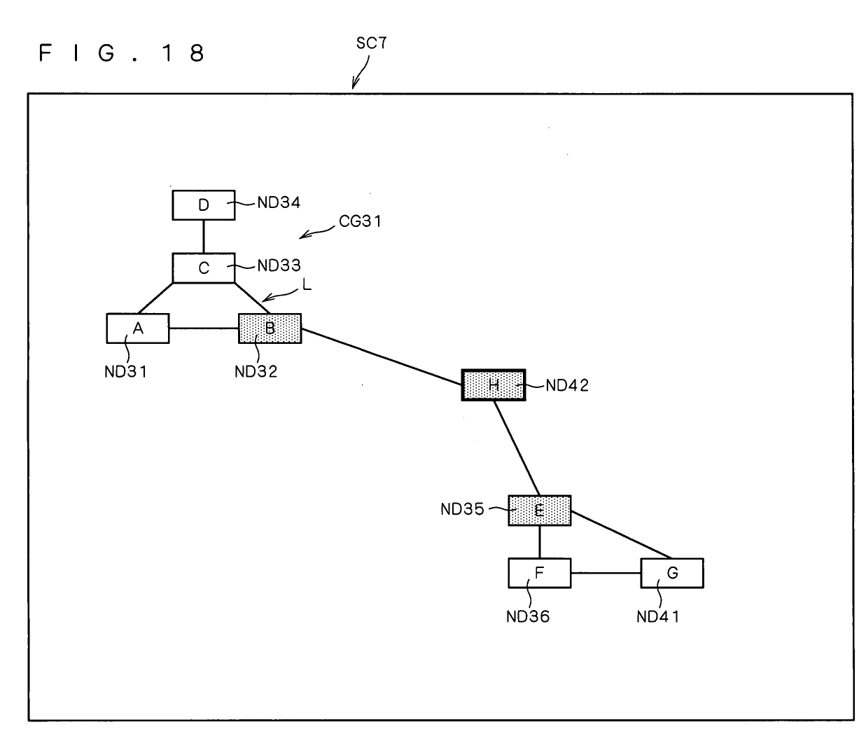

FIGS. 16 and 17 are diagrams illustrating co-author relation screens SC5 and SC6, respectively. The co-author relation screen SC5 is displayed in the case of using the search keyword “DENSIKARUTE”, and the co-author relation screen SC6 is displayed in the case of using the search keywords of “DENSIKARUTE” and “electronic health record”.

On the co-author relation screen SC5, authors A, B, C, D, E, and F are displayed as nodes ND31, ND32, ND33, ND34, ND35, and ND36, respectively, and the nodes corresponding to the co-authors in extracted papers are connected via a line L. That is, the co-author relation screen is a diagram in which information of the authors as data elements included in the data group to be searched is connected to each other by using nodes. By the display, the user can recognize the relations among co-authors at a glance. On the co-author relation screen SC5, two co-author groups CG31 and CG32 are displayed.

Similarly, on the co-author relation screen SC6, in addition to the nodes ND31 to ND36 displayed on the co-author relation screen SC5, nodes ND41, ND42, ND43, and ND44 corresponding to authors G, H, I, and J, respectively, are displayed. On the co-author relation screen SC6, the co-author groups CG31 and CG32 separated on the co-author relation screen SC5 are connected into a co-author group CG41 by the node ND42 corresponding to the author H. A new co-author group CG42 which is not included in the co-author relation screen SC5 is displayed on the co-author relation screen SC6.

By facilitating editing of the search keyword group in the information retrieval system 1A, such a change in the co-author relations can be easily recognized. A larger amount of co-author relation information than the co-author relation information obtained from a keyword group came up with in the user's mind can be therefore obtained.

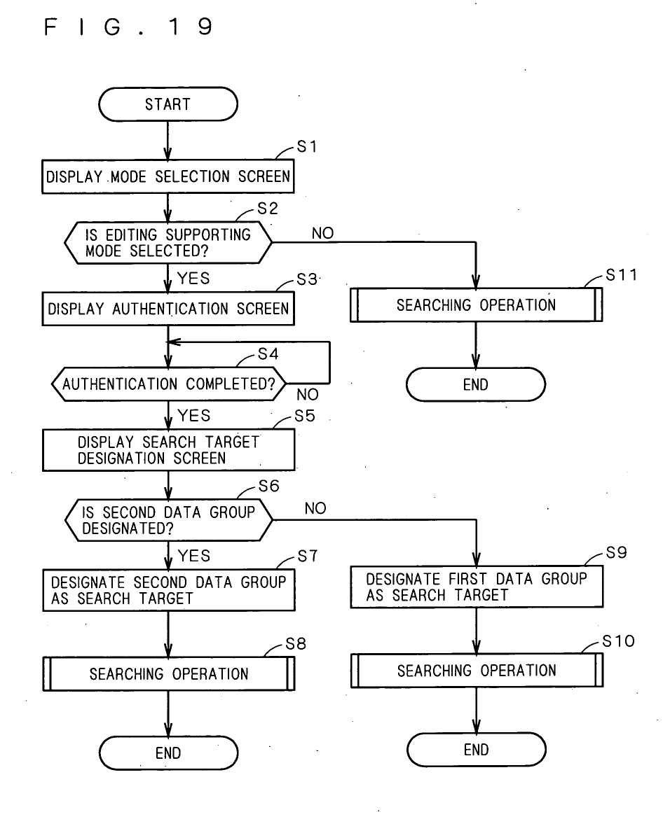

FIG. 18 is a diagram illustrating the co-author relation screen SC7. The co-author relation screen SC7 shows the co-author relation of the author H as a center. The co-author relation screen SC7 is obtained by eliminating the co-author group CG42 having no relation with the author H from the co-author relation screen SC6 shown in FIG. 17. In the co-author relation screen SC7, authors having the co-author relation with the author H within three hierarchical levels are shown. The author H as a center is indicated by a thick frame, and the author H and co-authors having the direct co-author relation with the author H are displayed in a mode different from that of the other authors (for example, in a different color).

To a word (or a term) newly registered in the user dictionary 135, the uniform initial score (for example, 10) is given. In the information retrieval system 1A, in the case where a word (or a term) registered in the user dictionary 135 is displayed as a search keyword candidate on the keyword candidate display screen and is actually used for re-search, a predetermined number (for example, 1) is added to the score 133a. On the other hand, in the case where a word (or a term) registered in the user dictionary 135 is displayed as a search keyword candidate on the keyword candidate display screen and is not actually used for re-search, the predetermined number (for example, 1) is subtracted from the score 133a. When the score of the word (or the term) becomes below a predetermined number (for example, 0), the word (or the term) may not be displayed as a search keyword candidate on the keyword candidate display screen. Obviously, if the user registers the word (or the term) again after the word (or the term) disappears from the keyword candidate display screen, the initial score is newly given to the word (or the term) and the word (or the term) is displayed as a search keyword candidate.

The score 133a is also used for determining display order information. For example, a word (or a term) having a higher score is displayed in a higher place in the keyword candidate display screen. Further, the display control with the score may be also applied to a word (or a term) registered in the default dictionary 134. The numerical values of the score are just examples, and actual values can be properly changed in consideration of the application of the information retrieval system 1A and the like.

Operation

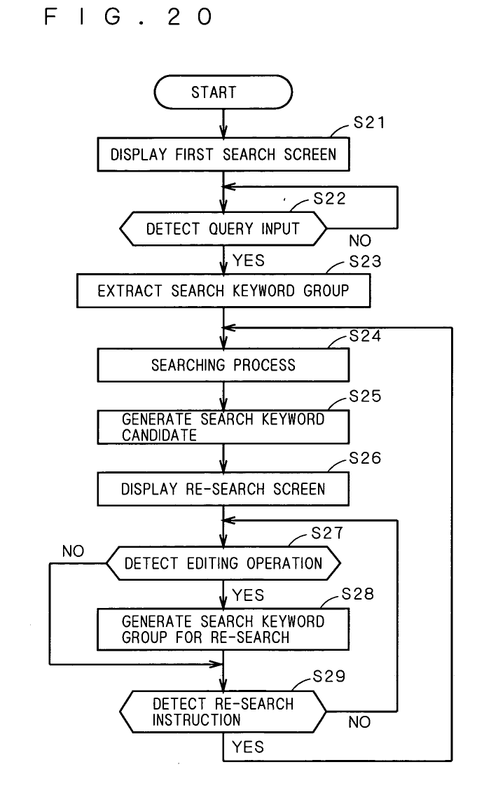

FIG. 19 is a flowchart showing schematic operations of the information retrieval system 1A related to the editing supporting function.

In step S1, the user display unit 14 generates the mode selection screen SCa and the mode selection screen SCa is displayed on the display 17.

In step S2, whether the editing supporting mode is selected on the mode selection screen SCa or not is determined. When the editing supporting mode is selected, the program advances to step S3. When the normal search mode is selected, the program advances to step S11.

In step S3, the user display unit 14 generates the authentication screen SCb and the authentication screen SCb is displayed on the display 17.

In step S4, whether the authenticating process is completed on the authentication screen SCb or not is determined. The determination in step S4 is repeated until the authenticating process completes. After completion of the authenticating process, the editing support function is enabled, and the program advances to step S5.

In step S5, the user display unit 14 generates the search target designation screen SCc and the search target designation screen SCc is displayed on the display 17.

In step S6, whether the second data group DM2 was designated on the search target designation screen SCc or not is determined. When the second data group DM2 is designated, the program advances to step S7. When the first data group DM1 is designated, the program advances to step S9.

In step S7, the second data group DM2 is designated as a search target.

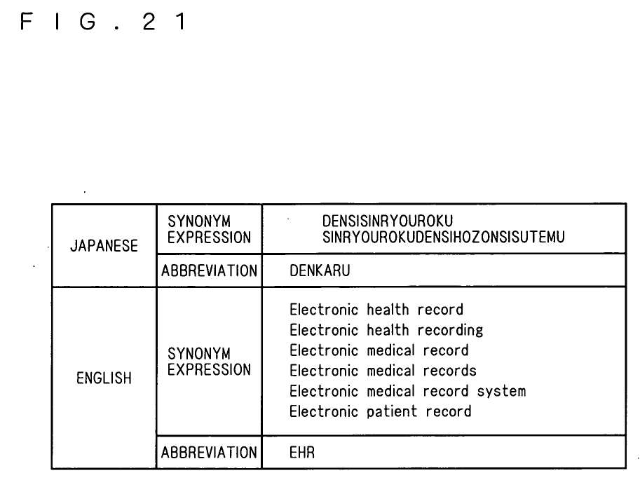

In step S8, operations on a series of searches shown in FIG. 20 are performed on the second data group DM2 as a search target.

In step S9, the first data group DM1 is designated as a search target.

In step S10, the operations on the series of searches shown in FIG. 20 are performed on the first data group DM1 as a search target.

FIG. 20 is a flowchart showing an outline of the operations on the series of searches in the information retrieval system 1A.

Steps S21 to S26 are a step group related to the first search.

First, the user display unit 14 generates a first search screen and the first search screen is displayed on the display 17 (step S21). Subsequently, the presence/absence of a query input by the user is detected (step S22). In the case where the query input is not detected in step S22, the operation flow returns to step S22. In the case where the query input is detected in step S22, the operation flow moves to the following step S23. Therefore, in the information retrieval system 1A, the operations in step S23 and subsequent steps are executed in response to the query input of the user.

Further, the keyword determining unit 11 extracts a search keyword group from the query by also using help of the keyword candidate determining unit 13 and outputs the extracted search keyword group to the searching unit 12 (step S23). The searching unit 12 executes the searching process by using the search keyword group and outputs the search result to the user display unit 14 (step S24).

On the other hand, the keyword candidate determining unit 13 generates a search keyword candidate from the search keyword group and supplies the search keyword group and the search keyword candidate to the user display unit 14 (step S25).

In the following step S26, the user display unit 14 generates a re-search screen and the re-search screen is displayed on the display 17. The re-search screen includes the search result supplied in step S24 and the search keyword group and the search keyword candidate supplied in step S25. After that, the operation flow shifts to step S27.

Steps S27 to S29 are a step group related to re-search.

In step S27, the presence/absence of the editing operation is detected. In the case where the editing operation is detected in step S27, the operation flow moves to step S28. In the case where the editing operation is not detected, the operation flow moves to step S29, not step S28.

In step S28 executed in response to the editing operation, the search keyword group corresponding to the editing operation in step S27 is changed, thereby generating the search keyword group for re-search. After that, the operation flow moves to step S29.

In step S29, a re-search instruction from the user, that is, click on the re-search button BT18 is detected. When the re-search instruction is detected, the operation flow moves to step S24. When the re-search instruction is not detected, the operation flow moves to step S27. By steps S27 to S29, the editing operation standby state is maintained in the information retrieval system 1A until the re-search instruction is given from the user. In response to the editing operation, the search keyword group for re-search is updated. Obviously, when the editing operation is not performed, the search keyword group used for the immediately preceding searching process is maintained in the information retrieval system 1A. When the re-search instruction is given, the searching process is re-executed by using the search keyword group for re-search in step S24.

The above-described editing operation can be performed in each of the normal searching mode and the editing supporting mode which can be used only by the data editor. Specifically, additional registration or the like of a synonym is performed in response to an input to the input unit 15 by the data editor in the editing work state, the logic model is updated, and the searching function is developed. Therefore, the intention of the data editor is also reflected in the logic model in the editing work. Consequently, a general user using the information retrieval system 1A can also use, for example, the searching function developed by utilizing knowledge of terms and the like which can be obtained only by the data editor.

### EXAMPLE OF USING EDITING SUPPORTING FUNCTION

Two examples of using the editing supporting function described above will be described below.

### Use Example 1

An example of the case where a number of papers are sent for an academic meeting to be held of a society and the user wishes to compile papers on DENSIKARUTE (i.e. electronic medical record) among the number of papers to form a session will be described.

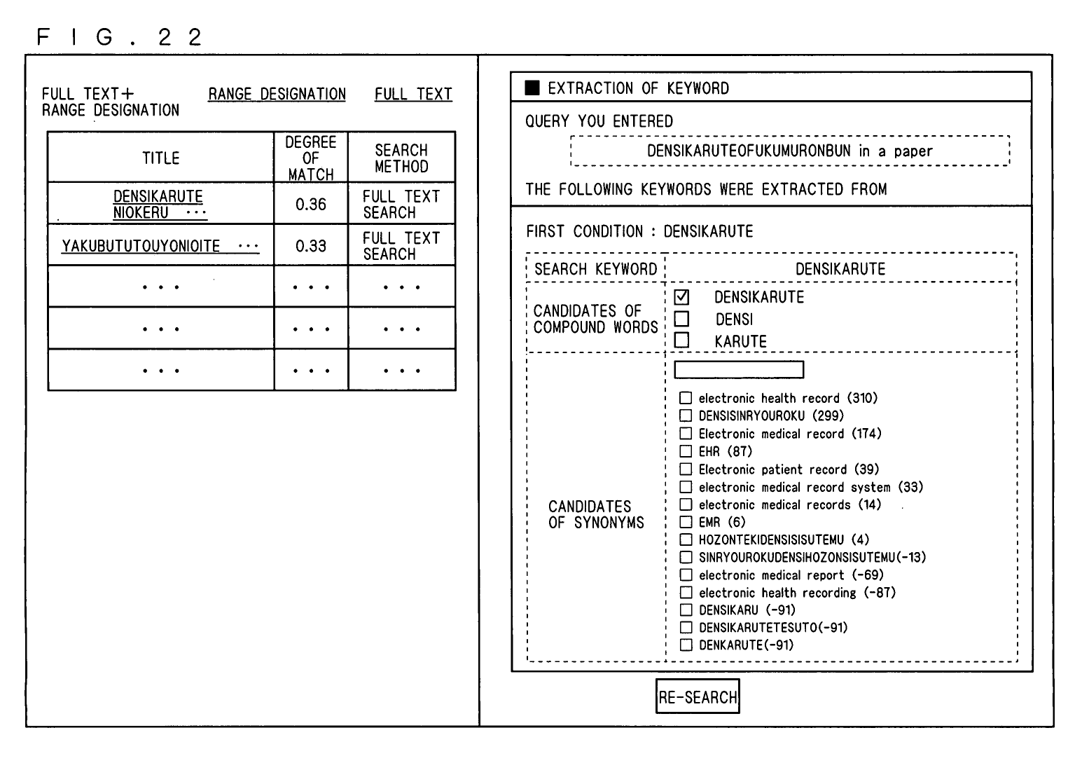

In this case, a compiler tries to collect papers including a term of “DENSIKARUTE” in the title, abstract, and keywords of the papers. However, as shown in FIG. 21, there are many synonyms for “DENSIKARUTE” and, particularly, keywords are often described in English. Further, “DENSIKARUTE” is often erroneously translated to an improper term such as “electric health record”. Therefore, it is extremely difficult for a compiler to collect papers on DENSIKARUTE (i.e. electronic medical record) without fail in consideration of various synonyms and inappropriate terms.

To solve such a problem, in the information retrieval system 1A, many synonyms are additionally registered by a number of users with respect to “DENSIKARUTE” by the search supporting function. Therefore, in the case where a natural sentence “DENSIKARUTEOFUKUMURONBUN in paper” is supplied as a query to the information retrieval system 1A, for example, the re-search screen as shown in FIG. 22 is displayed on the display 17.

In the re-search screen shown in FIG. 22, a number of synonyms added based on the knowledge of a number of users are listed. On the right side of each of the synonyms, a score indicative of the degree that the synonym is supported as a synonym of the search keyword is provided.

Therefore, the compiler properly selects synonyms listed on the re-search screen and performs a search on the second data group DM2 to be edited in the editing supporting mode, thereby enabling papers on DENSIKARUTE (i.e. electronic medical record) can be collected without fail in consideration of various synonyms and inappropriate terms.

The compiler can also know terms supported by a number of people as terms indicative of DENSIKARUTE (i.e. electronic medical record) by referring to the scores given to the synonyms, so that the most supported term can be employed as the session name. An inappropriate term or expression of paper data extracted by making a search using inappropriate terms as search keywords can be corrected, or the compiler can ask the author of the paper data to correct it.

In addition, the following is also possible. First, the number of papers extracted by a searching process using a certain search keyword on the first data group DM1 is recognized. After that, the searching process is also performed on the second data group DM2 by using a search keyword group by which a certain number of papers are to be extracted, and a certain number of papers are extracted as a result. The compiler can recognize that a session related to the search keyword group is to be formed.

It is also possible to determine a paper whose degree of match is equal to or larger than a predetermined value by referring to the degree of match displayed on the right side of the title of each paper in the search result display screen of the re-search screen as a paper describing the search keyword group, and classify the paper as a paper to be added to a session.

As described above, the compiler (data editor) adds the session name and the like to paper data and classifies the paper data on the basis of various information obtained by the editing supporting function, and adds new paper data to the first data group DM1. In such a manner, the editing work utilizing the knowledge of a number of users can be realized. On the other hand, after completion of the editing work, a general user other than the data editor can perform a searching process on the first data group DM1 as a search target to which new paper data is added.

### Use Example 2

As described above, by the searching process using synonyms accumulated by the searching supporting function, a work of classifying a number of papers to a plurality of sessions is facilitated. Further, it is also possible to determine the chairperson of each session and form a session by collecting papers having a deep relation with the chairperson.

For example, it is assumed that a keyword representing a session is determined as “DENSIKARUTE”. In this case, the first data group DM1 is set as a search target and a central figure in the co-author relation is determined by referring to the co-author relation screen on the “DENSIKARUTE” and “electronic medical record” as shown in FIG. 17, and the central figure can be selected as the chairperson as a key person. For example, in the co-author relation screen SC6 of FIG. 17, an author H connecting the co-author group CG31 and a co-author group formed by authors E, F, and G can be determined as a key person of papers related to DENSIKARUTE (or electronic medical record). From such information, the compiler can designate the author H as the chairperson of the session on DENSIKARUTE (or electronic medical record).

Next, paper data of another meeting, that is, paper data included in the second data group DM2 is set as an object. As shown in FIG. 18, the co-author relation screen indicating the co-author relations with the author H as a chairperson as a center is displayed on the display 17. Papers in the co-author relations displayed on the co-author relation screen are set as papers deeply related to the author H, and a session can be formed by collecting the papers.

There is a method of using the editing supporting function as follows. While setting the first data group DM1 as a search target, central figures of co-author relations are narrowed to a few people by referring to the co-author relation screen on the “DENSIKARUTE” and “electronic medical record” as shown in FIG. 17. After that, the second data group DM2 is set as a search target, and a chairperson of a new session is determined from the few central figures selected in advance with reference to the co-author relation screen on the “DENSIKARUTE” and “electronic medical record” as shown in FIG. 17. Information of the chairperson determined in such a manner is used at the time of forming a program of a meeting.

Although FIGS. 17 and 18 show the co-author relation screens in which the number of co-authors having the co-author relation is small. In reality, a larger number of authors having the co-author relations are displayed on the co-author relation screen.

As described above, in the information retrieval system 1A according to the preferred embodiment of the present invention, the searching function in which the logic model expressing the logic guide in the searching process is developed in response to a request for the searching process by the user can be utilized also for the second data group DM2 to be edited. With the configuration, in the case of adding new data to the database 16 in the information retrieval system 1A, a classifying work such as classification to sessions is facilitated. That is, the editing work of adding new contents to a database can be facilitated.

A person who can utilize the searching function of the information retrieval system 1A for a data group to be edited is limited to a data compiler as a specific user. Consequently, a situation such that an indefinite number of users are confused by a result of the searching process performed also on a data group to which the editing work has not been finished can be avoided.

By reflecting the intention such as a synonym and the like additionally registered by the data editor in the editing work into the logic model, the searching function is developed. With such a configuration, the searching function developed by utilizing knowledge and the like of only a data editor can be also used by a general user.

The searching function developed by additionally registering a synonym and the like to a search keyword can be also used to the second data group DM2 to be edited. Consequently, for example, the searching process using a proper search keyword group can be executed on a data group to be edited, so that clustering or the like of contents included in the data group to be edited is facilitated.

In the editing work, the data editor can refer to the relations among data elements such as co-author relation screens indicative of the co-author relation of authors of papers included in the first and second data groups DM1 and DM2. Consequently, for example, a single session can be formed by collecting a plurality of pieces of paper data having the co-author relations displayed on the co-author relation screen, so that clustering or the like of the contents included in the data group to be edited is further facilitated.

Modifications

Although the preferred embodiment of the present invention has been described above, the present invention is not limited to the above description.

For example, the data group to be searched is information obtained by converting a plurality of papers into an electronic form in the foregoing preferred embodiment. However, the present invention is not limited to the information. For example, the data group may be information obtained by converting a plurality of reports constructed by short sentences into an electronic form. An example of the report constructed by short sentences is an X-ray film reading report (or film reading report) which is generally used in hospitals.

The case where the data group to be searched includes information obtained by converting a film reading report into an electronic form (film reading report information) will be described below.

At the time of generation of a film reading report used in a medical institution, due to the nature of the report, a final diagnosis is not conducted by a primary doctor.

For example, in the case where a primary doctor makes a decision of taking slice pictures of brains by a CT scan, a radiation physician captures images of the brains by a CT scan, and prepares a film reading report constructed by images captured by the CT scan and observation. In the film reading report, the radiation physician writes the name of suspected disease as the observation. After the primary doctor receives the film reading report, the doctor makes a final diagnosis of determining the name of an actual disease. A difference sometimes occurs between the name of a disease written by the radiation physician and the actual name of a disease determined by the final diagnosis. For example, although a radiation physician suspects a stomach ulcer, a primary doctor makes a final diagnosis of stomach cancer. Therefore, it is necessary to make the film reading report information temporarily registered and unused for a search for cases at the time of registering the film reading report information into the case database.

At the time point a certain amount of film reading report information already used for a final diagnosis is stored (temporarily registered) in a case database, the searching process is performed using the editing supporting function, the film reading report information is classified, and an editing work of registering the information to a case database may be performed.

Concrete examples of the work of editing the film reading report information will be described below.

### Concrete Example 1

For example, it is assumed that film reading report information registered in a case database is classified to a plurality of groups including a stomach cancer group and a stomach ulcer group, and a number of pieces of film reading report information in which final diagnoses of stomach cancer and stomach ulcer are temporarily registered as a new search target data group in the case database.

In the case of registering a number of pieces of film reading report information included in the new search target data group into the case database, a number of pieces of film reading report information have to be classified into the stomach cancer group and the stomach ulcer group. However, there is a case such that the data editor does not know that a number of pieces of film reading report information registered in the case database are classified to the plurality of groups including the stomach cancer group and the stomach ulcer group.

In such a case, first, by referring to the data registered, the data editor understands that it is sufficient to classify the data to stomach cancer and stomach ulcer. However, for example, with respect to “stomach cancer”, there is a case that a synonym such as “gastric cancer” is used also for the name of the disease, and it is difficult to classify the temporarily registered film reading reports with reliability without fail. Therefore, a searching process using “stomach cancer” and “stomach ulcer” as search keywords and using a searching function developed by additional registration of synonyms and the like is performed on the data group of the temporarily registered film reading report as a search target. By the searching process, all of film reading reports in which a final diagnosis of stomach cancer is made and film reading reports in which a final diagnosis of stomach ulcer is made can be extracted. As a result, the editing work of classifying all of the temporarily registered film reading report information to the stomach cancer group and the stomach ulcer group, and registering the information with reliably can be performed.

By properly adding the new data classified as described above to the case database, the case database can be properly grown.

### Concrete Example 2

A method of an operation or the like is not written in the film reading report. However, a method of an operative treatment or the like is written in an electronic medical record and the like. Consequently, the film reading report information is temporarily registered in the case database. After that, the information is combined with an electronic medical record or the like in which an operative treatment method is written, and the resultant is temporarily registered as information of a general report on a patient (also referred to as “patient general report information”) into the case database. While using the editing supporting function, the film reading report information (that is, the patient general report information) can be classified by operative treatment method.

With respect to stomach cancer, the operative treatment method such as cancer removing method varies depending on the location of cancer, the upper part, intermediate part, or lower part of the stomach. Consequently, there may be a case of classifying all of the film reading report information on stomach cancer into the same group but also a case of classifying the film reading report information on stomach caner by operative treatment methods.

The case of classifying the patient general report information by operative treatment methods at the time point a number of pieces of the patient general report information in which the operative treatment method of stomach cancer is written are accumulated in the case database will be described below.

For example, it is assumed that there are mainly three operative treatment methods depending on the part in which cancer exists. First, by referring to the patient general report information registered, it is understood to classify new patient general report information on stomach cancer into mainly three operative treatment methods. However, for example, expression on the operative treatment methods slightly varies among doctors. Consequently, the operative treatment methods are set as search keywords, and the searching process using the searching function developed by additional registration of synonyms and the like is performed on a data group of temporarily registered patient general report information. By the searching process, all of the patient general report information corresponding to the three operative treatment methods can be extracted. As a result, the editing work of classifying all of the temporarily registered patient general report information into the three operative treatment methods and registering the classified data can be performed.

By properly adding the new data classified as described above into the case database, the case database can be properly grown.

Another example of a report constructed by short sentences is a report of complaints on various services and countermeasures for the complaints (also referred to as “user complaint report”). With respect to such a user complaint report, for example, a report in which only the contents of the complaint is written is temporarily registered in a database. After that, when the countermeasure against the complaint is determined, the countermeasure is additionally written in the user complaint report. An editing work of classifying, by countermeasure, the user complaint reports temporarily registered using the searching process by the searching function developed according to the intention of the user and registering the classified data into the database can be performed.

Although the co-author relation is used for the editing work in the foregoing preferred embodiment, the present invention is not limited to the mode. For example, in the case of searching the first data group DM1, information indicative of the relation between a search keyword and a keyword (primary keyword) added to paper data extracted by the search keyword may be added to the first data group DM1 and, in response to a predetermined operation, the relation between the search keyword and the primary keyword may be illustrated. A keyword supported by authors of papers is grasped from the diagram illustrating the relation between the search keyword and a primary keyword (keyword relation diagram), and may be used as a session name. It is also possible to store the use frequency of a search keyword used when extracted by a search by paper data and give score to the use frequency so as to be displayed as a parameter indicative of the strength of connection between the search keyword and the primary keyword in a keyword relation diagram. Although an author of a paper tends to use a specialty term, by referring to such information, the compiler can employ a search keyword which is frequently used by a number of users as a session name as a keyword generally supported.

Although the logic model is updated by adding synonyms to the search keyword by the user and the search efficiency is increased in the foregoing preferred embodiment, the present invention is not limited to this embodiment. For example, in a manner similar to the technique disclosed in Japanese Patent Application Laid-Open No. 2004-234404, by optimizing the data structure of the first data group DM1 as a search target, the search efficiency may be increased.

Although the candidates of synonyms are not included in the search keyword group unless the user specify, the present invention is not limited to this embodiment. For example, the candidates of synonyms may be automatically added to the search keyword group in the case where the score is not less than a predetermined value (100, for example). The search efficiency may be increased by employing such a configuration.

While the invention has been shown and described in detail, the foregoing description is in all aspects illustrative and not restrictive. It is therefore understood that numerous modifications and variations can be devised without departing from the scope of the invention.

What is claimed is:

1. An information retrieval system in which a logic model expressing a logic guide in a searching process is developed in response to a request for a searching process from a user, comprising:
a storage that stores a first data group;
a first searching unit for searching in said first data group in response to a first search condition entered by an operation of said user and obtaining a first search result on the basis of said logic model;
a registering unit for registering a second data group into said storage so as to be distinguished from said first data group; and
a second searching unit for searching in said second data group in response to a second search condition entered by an operation of said user on the basis of said logic model in an editing work state in which said second data group is registered in said storage, and obtaining a second search result.

2. The information retrieval system according to claim 1, wherein
said second searching unit obtains said second search result in response only to said second search condition entered by an operation of a specific user.

3. The information retrieval system according to claim 2, further comprising:
a logic model updating unit for updating said logic model in response to an input of said specific user in said editing work state.

4. The information retrieval system according to claim 1, wherein
said logic model is developed by adding a synonym to a search keyword related to said first search condition in response to an operation of a user.

5. The information retrieval system according to claim 1, wherein
a data structure of said first data group is optimized on the basis of said logic model.

6. The information retrieval system according to claim 1, wherein
RDF is used for expressing said first and second data groups.

7. The information retrieval system according to claim 1, wherein
said storage stores at least said first data group in a structured manner, and
said information retrieval system further comprises an output unit for visibly outputting relations among data elements included in said second data group in said editing work state.

8. The information retrieval system according to claim 1, wherein
said storage stores at least said second data group in a structured manner, and
said information retrieval system further comprises an output unit for visibly outputting relations among data elements included in said second data group in said editing work state.

9. The information retrieval system according to claim 1, wherein
information included in said first and second data groups includes information of at least one of a document, a paper, and a report.

10. The information retrieval system according to claim 1, wherein
information included in said first and second data groups includes at least information of a report constructed by a short sentence.

11. The information retrieval system according to claim 1, wherein
as at least one searching process performed by at least one of first and second searching units, an information processing including a language processing is used.
